(19) United States
(12) Patent Application Publication
(10) Pub. No.: US 2010/0180838 A1
(43) Pub. Date: Jul. 22, 2010

(54) ALTERNATIVE FUEL INJECTION SYSTEM AND METHOD FOR AN INTERNAL COMBUSTION ENGINE

(75) Inventors: JOSEPH E. LEWIS, III, COCOA BEACH, FL (US); ANDREW A. ROBBINS, HOUSTON, TX (US)

Correspondence Address: GARLICK HARRISON & MARKISON, P.O. BOX 160727, AUSTIN, TX, 78716-0727, US

(73) Assignee: H2 SOLUTIONS, LLC, HOUSTON, TX (US)

(21) Appl. No.: 12/502,733

(22) Filed: Jul. 14, 2009

Related U.S. Application Data
(63) Continuation-in-part of application No. 12/178,852, filed on Jul. 24, 2008.
(60) Provisional application No. 61/081,714, filed on Jul. 17, 2008.

(51) Int. Cl. F02B 43/08; F02B 7/00

(52) U.S. Cl. 123/3; 123/577

(57) ABSTRACT

An internal combustion engine that includes an engine block assembly, an air intake system coupled to the engine block assembly and an alternative fuel delivery system coupled to the air intake system. The alternative fuel delivery system includes a control module that monitors measurements of operational data of the internal combustion engine from the one or more sensors. In response to the operational data, the control module determines a fuel flow rate of alternative fuel and controls injection of the alternative fuel to provide the determined fuel flow rate of alternative fuel into the air intake system.

### CROSS REFERENCE TO RELATED APPLICATIONS

This US patent application claims priority as a continuation-in-part application under 35 USC §120 to a prior filed utility patent application entitled, “Hydrogen Delivery System and Method for an Internal Combustion Engine,” having a filing date of Jul. 24, 2008 and an application Ser. No. 12/178,852, which claims priority under 35 U.S.C. §119 to a provisionally filed patent application entitled, “Hydrogen Delivery System and Method for an Internal Combustion Engine,” having a provisional filing date of Jul. 17, 2008, and a provisional application Ser. No. 61/081,714, both of which are hereby incorporated herein by reference.

### BACKGROUND OF THE INVENTION

1. Field of the Invention

The application generally relates to internal combustion engines, and more particularly to an improved system and method for alternative fuel delivery to an internal combustion engine.

2. Description of the Related Art

In an internal combustion engine, fuel and an oxidizer are combined in a cylinder or combustion chamber. Typically engines use either a spark method or a compression method to achieve ignition. Through ignition, an exothermic chemical reaction or combustion occurs in the cylinder in which hot gases expand to move a part of the engine, such as a piston or a rotor. Typically, the oxidizer for an internal combustion engine is air, and the fuel is a hydrocarbon based fuel derived from petroleum or biomass, such as diesel, gasoline, petroleum gas, ethanol, biodiesel or propane or combination thereof.

The increasing cost of petroleum fuels for internal combustion engines has created a demand for greater fuel efficiency. One approach that has been developed is the addition of hydrogen to the combustion process. It has been found that when hydrogen is mixed with a hydrocarbon based fuel in the cylinder of an internal combustion engine, there is an improved combustion efficiency and a reduction of noxious emissions. In current systems, hydrogen is added to the air that is introduced into the cylinder. Typically, the same volume of hydrogen is added to the air regardless of air flow rate, engine load or engine revolution per minute (RPM) considerations.

As such, there is a need for an improved system and method for hydrogen delivery to an internal combustion engine.

### BRIEF SUMMARY OF THE INVENTION

The present invention is directed to a system and method for hydrogen delivery to an internal combustion engine as described in the following Brief Description of the Drawings, the Detailed Description of Embodiments of the Invention and The Claims. The features and advantages of the present invention will become apparent from the following detailed description of the invention made with reference to the accompanying drawings.

### BRIEF DESCRIPTION OF THE DRAWINGS

FIG. 1 illustrates a schematic block diagram of an embodiment of an internal combustion engine with a hydrogen delivery system in accordance with the present invention.

FIG. 2 illustrates a schematic block diagram of an embodiment of a hydrogen delivery system in accordance with the present invention.

FIG. 3 illustrates a schematic block diagram of another embodiment of the hydrogen delivery system in accordance with the present invention.

FIG. 4 illustrates a schematic block diagram of another embodiment of the hydrogen delivery system in accordance with the present invention.

FIG. 5 illustrates a logic flow diagram of an embodiment of a method for hydrogen delivery in accordance with the present invention.

FIG. 6 illustrates a logic flow diagram of another embodiment of a method for hydrogen delivery in accordance with the present invention.

FIG. 7 illustrates a schematic block diagram of an embodiment of an alternative fuel delivery system in accordance with the present invention.

FIG. 8 illustrates a schematic block diagram of another embodiment of the alternative fuel delivery system in accordance with the present invention.

FIGS. 9a and 9b illustrate a schematic diagram of an embodiment of operation of a control module in the alternative fuel delivery system in accordance with the present invention.

FIG. 10 illustrates a logic flow diagram of an embodiment of a method for alternative fuel delivery in accordance with the present invention.

FIG. 11 illustrates a schematic block diagram of an embodiment of a fuel flow rate database.

FIG. 12 illustrates a logic flow diagram of an embodiment of a method for alternative fuel delivery in accordance with the present invention.

FIGS. 13a, 13b and 13c illustrate graph diagrams of embodiments of example fuel flow rates in a fuel flow rate database.

FIG. 14 is a logic flow diagram of an embodiment of a method for determining fuel flow rates in response to engine efficiency data.

FIGS. 15a and 15b illustrate bar graphs of an embodiment of an example analysis performed to determine fuel flow rates.

FIG. 16 illustrates a schematic block diagram of an embodiment of a method for alternative fuel delivery in accordance with the present invention.

### DETAILED DESCRIPTION OF THE INVENTION

While the invention will be described in connection with the preferred embodiments, it will be understood that it is not intended to limit the invention to those embodiments. On the contrary, it is intended to cover all alternatives, modifications, and equivalents thereof. Similar parts will be labeled with the same numbers in the figures though a person of skill in the art would appreciate that various alternatives, modifications and equivalents may be substituted for such similar parts.

As described above, the current systems for hydrogen delivery introduce a constant volume of hydrogen to the air intake system of an internal combustion engine regardless of air flow rate, engine load or engine revolutions per minute (RPM) considerations. However, the air flow rate through the air intake system varies. By only injecting an unvarying volume of hydrogen, different hydrogen to air ratios are produced in the air intake system and in the cylinders during the combustion process. The differing values of hydrogen to air ratio in the cylinders creates inefficiencies in the combustion process. As such, there is a need for an improved system and method for hydrogen delivery to an internal combustion engine. An embodiment of the present invention monitors the flow rate of air and adjusts the delivery of hydrogen to the air intake system of the internal combustion engine to optimize the hydrogen to air ratio for the internal combustion engine.

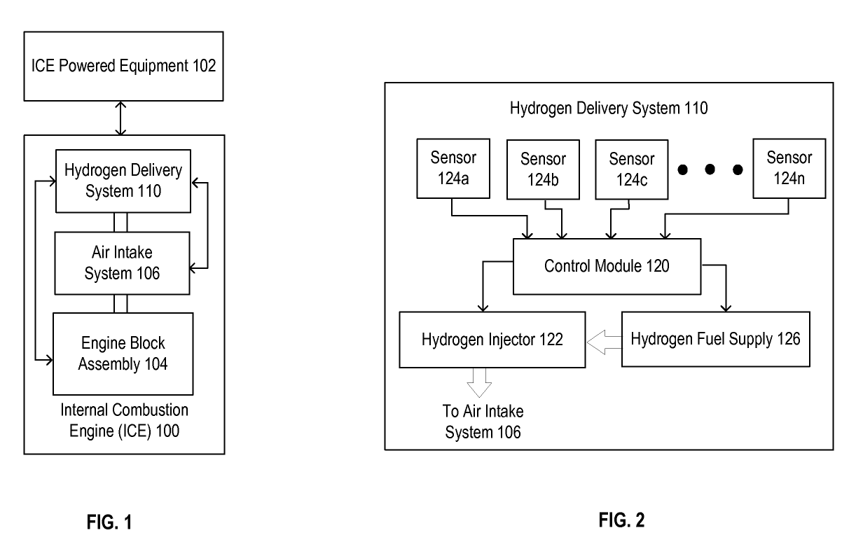

FIG. 1 is a schematic block diagram of an embodiment of an internal combustion engine with a hydrogen delivery system in accordance with the present invention. FIG. 1 illustrates an internal combustion engine (ICE) 100 coupled to an ICE powered equipment 102. The ICE powered equipment 102 includes for example, vehicles, airplanes, marine, locomotives, generators, oil field equipment and other applications. The ICE 100 includes an engine block assembly 104, an air intake system 106 and a hydrogen delivery system 110 coupled to the air intake system 106. The engine block assembly 104 includes the engine block, cylinders and pistons or rotors. The air intake system 106 delivers air to the cylinders in the engine block assembly 104. The air intake system 106 may include a turbocharger or supercharger and air filter.

In operation, the hydrogen delivery system 110 monitors the air flow rate through the air intake system 106 and controls the injection of hydrogen into the air intake system 106 to produce a desired, predetermined hydrogen to air ratio. In an embodiment, the hydrogen may be injected after the turbocharger in the air intake system 106. In another embodiment, the hydrogen may be injected before the turbocharger such that it pressurizes the air and hydrogen together. This helps to mix the air for a more homogenous blend.

FIG. 2 is a schematic block diagram of an embodiment of the hydrogen delivery system 110 in accordance with the present invention. The hydrogen delivery system 110 includes a control module 120, a hydrogen injector 122, one or more sensors 124a-n and a hydrogen fuel supply 126. The control module 120 is a processing device including a microprocessor, micro-controller, digital signal processor, microcomputer, central processing unit, field programmable gate array, programmable logic device, state machine, logic circuitry, analog circuitry, digital circuitry, or any device that manipulates signals (analog and/or digital) based on hard coding of the circuitry or operational instructions. The processing device may have an associated memory element, which may be a single memory device, a plurality of memory devices, or embedded circuitry of the control module. Such a memory device may be a read-only memory, random access memory, volatile memory, non-volatile memory, static memory, dynamic memory, flash memory, cache memory, and/or any device that stores digital information. Note that when the control module implements one or more of its functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry. Further note that, the memory element stores, and the control module executes, hard coded and/or operational instructions corresponding to at least some of the steps and/or functions illustrated in FIGS. 1-15 herein.

The sensors 124a-n measure operational data of the internal combustion engine 100. The sensors 124a-n may be coupled to the engine block assembly 104, the air intake system 106, hydrogen delivery system 110. The sensors 124a-n include, inter alia, thermometers, throttle body position sensors, revolutions per minute (RPM) sensor, pressure sensors, volume flow sensor, or mass air flow (MAF) sensor, such as hot film or hot wire sensor, barometric pressure sensor, Cam Shaft Position Sensor, Crank Shaft Position Sensor, Exhaust Back Pressure sensor, engine oil temperature sensor, engine oil pressure sensor, exhaust back pressure regulator, Fuel Delivery Control Signal, Glow Plug Relay, Hydraulically Actuated Electronically controlled Unit Injector, Intake Air Temperature, Injection Control Pressure, Injection Pressure Regulator, Injector Driver Module, Injector Driver Module Enable, Injection Control Pressure Regulator, Idle Validation Switch, Manifold Absolute Pressure (MAP), Manifold Air Temperature Sensor, Power train Control Module sensor, Speed Control Command Switch sensor, tachometer output sensor, Accelerator Position Sensor, Hall Effect Sensor, Magnetic Pick Up (Magnetic Speed Sensor), Thermister, Alternator Charge Output Signal, Vehicle Speed Sensor, Vacuum Sensor, Alternator Output Signal sensor, Glow Plug Control sensor, Vehicle Power Supply sensor, vehicle Reference Voltage sensor, and Wastegate Control sensor.

The hydrogen injector 122 may be a high pressure injector or a low pressure injector depending on the pressure of the hydrogen fuel and the volume of hydrogen needed to be injected into the air intake system 106.

In operation, one or more of the sensors 124a-n provide measurements of operational data of the internal combustion engine 110. The measurements of operational data may include, inter alia, measurements of mass air flow, volume air flow, vacuum, temperature, engine RPM, manifold absolute pressure, throttle position, engine load, crank shaft position or other operational data. The control module 120 monitors the operational data from the sensors 124a-n and determines a desired amount, either volume or mass, of hydrogen fuel to be injected into the air intake system 106 in response to the measurements of operational data. As the operational data changes, for example due to increase or decrease in the engine RPM, air flow, or other changes, the control module 120 continually updates the desired amount of hydrogen fuel to be injected into the air intake system 106. The control module 120 then controls the hydrogen injector 122 to provide a flow rate of hydrogen fuel to the air intake system 106 to deliver the determined amount of hydrogen fuel.

For example, in an embodiment, the control module 120 receives operational data of the engine RPM from one or more of the sensors 124a-n. Based on the engine RPM data, the control module 120 determines the desired amount, volume or mass of hydrogen fuel to be injected into the air intake system 106. The control module 120 then controls the hydrogen injector 122 to provide a flow rate of hydrogen fuel to the air intake system 106 to deliver the desired amount, volume or mass of hydrogen. In another embodiment, the control module 120 receives operational data of the throttle position from one or more of the sensors 124a-n. Based on the throttle position data, the control module 120 determines the desired volume or mass of hydrogen fuel to be injected into the air intake system 106. In another embodiment, the control module 120 receives operational data of the air flow from the mass air flow sensor through the air intake system 106. Based on the mass air flow data, the control module determines the desired volume or mass of hydrogen fuel to be injected into the air intake system 106.

In another embodiment, a sensor 124a-n provides operational data relating to the speed of a turbocharger rotor in the internal combustion engine 100. Based on the turbocharger rotor speed data, the control module 120 determines the desired amount of hydrogen fuel to be injected into the air intake system 106. In another embodiment, a sensor 124a-n provides operational data relating to amount of fuel, such as diesel or gasoline or other type of fuel, injected into a combustion chamber of the engine block assembly 104. The control module 120 may then correlate the fuel operational data to RPM of the engine block assembly 104 and determine the desired amount of hydrogen fuel to be injected into the air intake system 106. In another embodiment, a sensor 124a-n provides operational data relating to intake vacuum on a turbocharger or supercharger in an internal combustion engine 100. Based on the operational data of the intake vacuum, the control module 120 may determine the desired amount of hydrogen fuel to be injected into the air intake system 106. In an embodiment with an internal combustion engine 100 having a set operational RPM, such as a generator with a set RPM during operation, the control module 120 may determine the desired amount of hydrogen fuel to be injected into the air intake system 106 based on one or more measurements from the sensors 124a-n.

In another embodiment, the control module 120 receives one or more measurements of operational data comprising of, inter alia, mass air flow (MAF), volume air flow, intake vacuum on a turbocharger, turbocharger rotor speed, amount of fuel injected into the engine block assembly 104, temperature, engine RPM, manifold absolute pressure (MAP), throttle position, engine load and crank shaft position and determines an amount of hydrogen fuel to be injected into the air intake system 106 based on one or more of the measurements of operational data.

In an embodiment, the hydrogen fuel supply 126 is a tank or other type of container with high pressure hydrogen fuel. The hydrogen fuel may include hydrogen (H₂), oxygen, methane, propane, nitrogen, sulphur dioxide (SOX) and any combination of these gases or other hydrocarbon based gases. In another embodiment, the hydrogen fuel source 126 is a hydrogen generator, such as an electrolyzer. In this embodiment, the hydrogen fuel includes an electrolyzer gas consisting of hydrogen 2H₂ and oxygen O₂. The control module 120 monitors the hydrogen fuel supply 126 to determine a pressure of the hydrogen fuel. Depending on the pressure of the hydrogen fuel, the type of hydrogen fuel, the control module 120 controls the opening and closing of the hydrogen injector 122. The hydrogen injector 122 injects the desired flow rate of hydrogen fuel into the air intake system 106 in response to control signals from the control module 120.

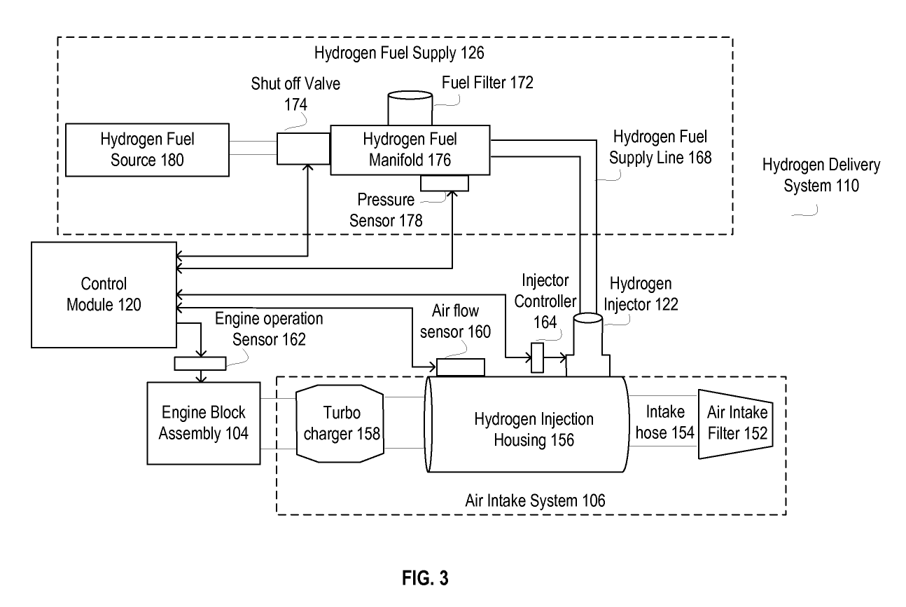

FIG. 3 illustrates a schematic block diagram of an embodiment of the hydrogen delivery system 110 in accordance with the present invention. The air intake system 106 includes an air intake filter 152, an intake hose 154, a hydrogen injection housing 156 and a turbocharger 158. An air flow sensor 160 is coupled to the hydrogen injection housing 156 to provide measurements of air flow in the hydrogen injection housing 156. In an embodiment, the air flow sensor 160 is a mass air flow sensor, such as a hot wire or hot film anemometer. In an embodiment, an engine operation sensor 162 is coupled to the engine block assembly or component of the internal combustion engine 100. The engine operation sensor 162 is operable to detect whether the engine is operational by detecting any RPM of the engine 100 or ignition or other means. The air flow sensor 160 and engine operation sensor 162 each may comprise one of the sensors 124a-n described in FIG. 2. Other sensors 124a-n may also provide one or more additional measurements to the control module 120 as described with respect to FIG. 2.

Referring again to FIG. 3, the hydrogen fuel injector 122 is coupled to the hydrogen injection housing 156 in the air intake system 160. The hydrogen injection housing 156 may be mounted to an existing internal combustion engine 104 or be incorporated into manufacture of a new internal combustion engine 104. The hydrogen fuel injector 122 and air flow sensor 160 are mounted before the turbocharger 158. In another embodiment, the hydrogen fuel injector 122 and air flow sensor 160 may be mounted after the turbocharger 158. An injector controller 164 is coupled to the hydrogen fuel injector 122 and the control module 120. Depending on the implementation of the hydrogen fuel supply 126, the injector controller 164 may be incorporated as a component of the hydrogen injector 122 or as a separate component. The injector controller 164 is operable to control the opening and closing of the hydrogen injector 122 in response to control signals from the control module 120.

The hydrogen fuel supply 126 is coupled to the hydrogen injector 122. The hydrogen fuel supply 126 includes a hydrogen fuel supply line 168, a fuel filter 172, a shut off valve 174, a hydrogen fuel manifold 176, a pressure sensor 178 and a hydrogen fuel source 180. The pressure sensor 178 is coupled to the hydrogen fuel manifold 176 or shut off valve or other component of the hydrogen fuel supply 126 to measure the pressure of the hydrogen fuel. The pressure sensor 178 may comprise one of the sensors 124a-n described in FIG. 2. The shut off valve 174 is a solenoid valve or other safety valve. The fuel filter 172 is operable to filter contaminates and moisture from the hydrogen fuel.

In operation, the control module 120 receives pressure measurements from the pressure sensor 178 and determines whether the pressure is within operating conditions. When the pressure exceeds or falls below operating conditions, the control module 120 signals the shut off valve 174 to close to protect the system integrity. In addition, the control module 120 receives data from the engine operation sensor 162 and determines whether the internal combustion engine 100 is operational. In response to the determination that the engine 100 is operational, the control module 120 signals the shut off valve 174 to open or in response to a determination that the engine 100 is not operational, the control module 120 signals the shut off valve 174 to close. When the pressure is within operating conditions and the engine is operational, the control module 120 determines an air flow rate and then determines a flow rate of the hydrogen fuel into the air intake system 106 to produce a predetermined hydrogen to air ratio in the air intake system 106.

In an embodiment, the control module 120 may determine a volume air flow rate or a mass air flow rate. The control module 120 receives air flow measurements from the air flow sensor 160. The volume air flow rate is determined in response to the air flow measurements and air flow area of the hydrogen injection housing 156. The control module 120 may also receive air pressure measurements and air temperature measurements. From these measurements, the control module 120 may determine the approximate density of the air to determine mass air flow rate from the volume air flow rate. In another embodiment, the control module 120 may determine the mass air flow rate from the air flow sensor 160 when the air flow sensor is a mass air flow sensor such as a hot film or hot wire anemometer.

The control module 120 then determines the flow rate of the hydrogen fuel in response to the air flow rate. The control module 120 determines the hydrogen flow rate needed to provide a predetermined hydrogen to air ratio in the air intake system 106 or engine block assembly 104. The hydrogen flow rate determined also depends on the percentage of hydrogen in the hydrogen fuel. For example, when the hydrogen fuel source 180 is a tank with pressurized hydrogen, the hydrogen fuel will have a high concentration of hydrogen. However, when the hydrogen fuel source is an electrolyzer, the concentration of hydrogen in the hydrogen fuel is lower. The control module 120 is programmed with a concentration for the type of hydrogen fuel. Variable hydrogen concentrations in the hydrogen fuel are taken into consideration by the control module 120 when determining the fuel flow rate of hydrogen fuel needed to inject into the air intake system 106. To produce predetermined hydrogen to air ratio in the air intake system 106, the control module 120 determines the flow rate of the hydrogen fuel into the hydrogen injection housing 156 in response to air flow, engine load, RPM or other operational data and the concentration of hydrogen in the hydrogen fuel. The control module 120 then controls injection of the hydrogen fuel into the air intake system to produce the predetermined hydrogen to air ratio. As the engine load and RPM increases or decreases and the air flow rate increases or decreases, the control module 120 continues to monitor the operation data and adjust the hydrogen flow rate into the air intake system to produce a predetermined hydrogen to air ratio.

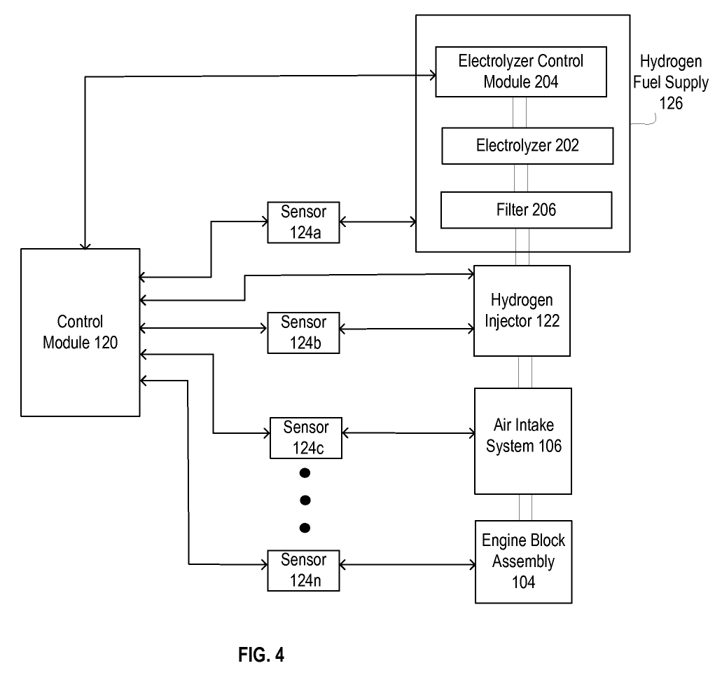

FIG. 4 is a schematic block diagram of another embodiment of the hydrogen delivery system 110 in accordance with the present invention. In this embodiment, the hydrogen fuel supply 126 includes an electrolyzer 202, electrolyzer control module 204 and filter 206. The electrolyzer 202 generates hydrogen and oxygen by a process of electrolysis that separates hydrogen from water. The electrolyzer 202 includes one or more electrodes in a water and electrolyte mixture. An electric current flows through the water and electrolyte mixture and oxygen (O₂) and hydrogen gas (H₂) are generated. The electrolyzer control module 204 controls the electrolyzer 202 and is operable to regulate the fuel production of the electrolyzer 202. By regulating the current flow, the volume of oxygen (O₂) and hydrogen gas (H₂) generated by the electrolyzer may be adjusted. The generated oxygen (O₂) and hydrogen gas (H₂) comprise the hydrogen fuel. The optional use of an oxygen separation filter 206 in the electrolyzer fuel supply 126 reduces the oxygen in the hydrogen fuel generated by the electrolyzer 202. In this embodiment, the hydrogen fuel supply 126 may also include check valves, expansion chambers, flashback prevention components, pressure switches or other components. The electrolyzer 202 may be powered by an alternator, battery or other means. The electrolyzer control module 204 is a processing device including a microprocessor, micro-controller, digital signal processor, microcomputer, central processing unit, field programmable gate array, programmable logic device, state machine, logic circuitry, analog circuitry, digital circuitry, or any device that manipulates signals (analog and/or digital) based on hard coding of the circuitry or operational instructions. The processing device may have an associated memory element, which may be a single memory device, a plurality of memory devices, or embedded circuitry of the control module. Such a memory device may be a read-only memory, random access memory, volatile memory, non-volatile memory, static memory, dynamic memory, flash memory, cache memory, and/or any device that stores digital information. Note that when the control module implements one or more of its functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry. Further note that, the memory element stores, and the control module executes, hard coded and/or operational instructions corresponding to at least some of the steps and/or functions illustrated in FIGS. 1-16 herein.

In operation, the control module 120 monitors, inter alia, the flow rate, pressure or volume of the hydrogen fuel from the hydrogen fuel supply 126. To adjust the hydrogen fuel generated, the control module 120 transmits an electrolyzer control signal to the electrolyzer control module 204. In response to the electrolyzer control signal, the electrolyzer control module 204 starts or terminates production of hydrogen fuel by the electrolyzer 202. The control module 120 receives data from the engine operation sensor 162 and determines whether the internal combustion engine 100 is operational. In response to the determination that the engine 100 is operational, the control module 120 signals the electrolyzer control module 204 to start production. In response to a determination that the engine 100 is not operational, the control module 120 signals the electrolyzer control module 204 to terminate production.

In another embodiment, the electrolyzer control module 204 regulates the voltage or current applied to the electrolyzer 202. The control module 120 can thus control the rate of production of hydrogen fuel in response to the flow rate needed at the hydrogen injector 122.

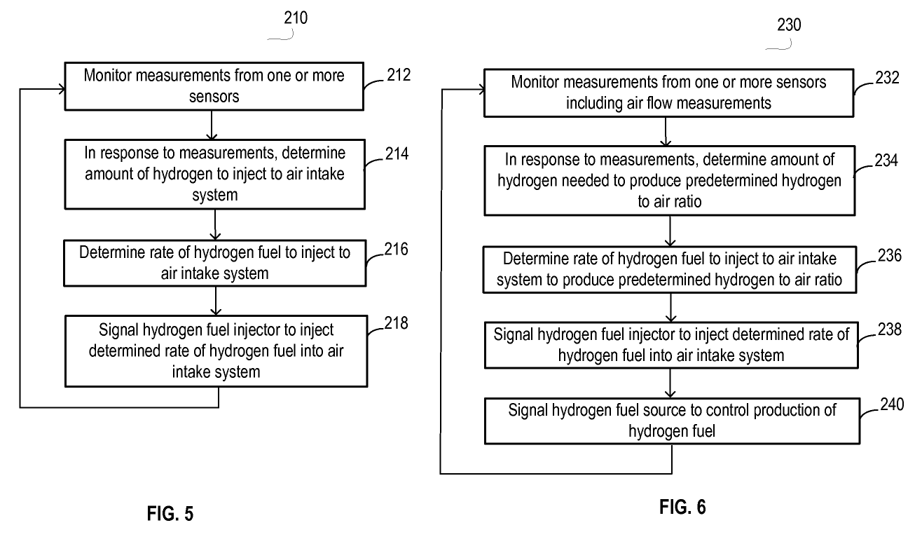

FIG. 5 is a logic flow diagram of a method 210 for hydrogen delivery to an air intake system 106 of an internal combustion engine 100 in accordance with the present invention. In step 212, one or more measurements from one or more sensors are monitored on a continuous basis as the operating conditions of the internal combustion engine change. For example, the measurements of operational data may include, inter alia, measurements of mass air flow, volume air flow, vacuum, temperature, engine RPM, manifold absolute pressure, throttle position, engine load and crank shaft position.

In step 214, an amount of hydrogen, either volume or mass of hydrogen, to inject into the air intake system 106 of the internal combustion engine 100 is determined. The control module 120 monitors the operational data from the sensors 124a-n and determines a desired amount, volume or mass, of hydrogen to be injected into the air intake system 106 in response to the measurements of operational data. For example, in an embodiment, the control module 120 receives operational data of the engine RPM. Based on the engine RPM, the control module determines the desired amount, either volume or mass, of hydrogen to be injected into the air intake system 106. The control module 120 then controls the hydrogen injector 122 to provide a flow rate of hydrogen fuel to the air intake system 106 to deliver the desired amount, either volume or mass, of hydrogen. In another embodiment, the control module 120 receives operational data of the throttle position. Based on the throttle position, the control module determines the desired volume or mass of hydrogen to be injected into the air intake system 106. In another embodiment, the control module 120 receives operational data of the manifold absolute pressure (MAP). Based on the MAP, the control module determines an amount, volume or mass, of hydrogen to be injected into the air intake system 106. In another embodiment, the control module 120 receives operational data of the mass air flow (MAF). Based on the MAF, the control module determines an amount, volume or mass, of hydrogen to be injected into the air intake system 106.

In step 216, a flow rate of hydrogen fuel is determined in response to the amount of hydrogen needed to inject into the air intake system. The flow rate of hydrogen fuel varies in response to the determined volume or mass of hydrogen and the hydrogen concentration in the hydrogen fuel. In step 218, the injection of hydrogen fuel into the air intake system is controlled to approximately meet the determined flow rate for hydrogen fuel.

FIG. 6 is a logic flow diagram of another embodiment of a method 230 for hydrogen delivery in accordance with the present invention. In step 232, measurements of the air flow through the air intake system are monitored along with other measurements from sensors 124a-n needed to determine the volume air flow or mass air flow through the air intake system 106. For example, the control module 120 may also receive air pressure measurements and air temperature measurements. From these measurements, the control module 120 may determine the approximate density of the air to determine mass air flow rate from the volume air flow rate. In another embodiment, the control module 120 may determine the mass air flow rate from the air flow sensor 160 when the air flow sensor is a mass air flow sensor such as a hot film or hot wire anemometer.

In step 234, the amount of hydrogen to produce a predetermined hydrogen to air ratio is determined in response to the air flow rate. In step 236, the flow rate of the hydrogen fuel needed to provide the amount of hydrogen for the predetermined hydrogen to air ratio in the air intake system 106 is determined. The hydrogen flow rate depends on the percentage of hydrogen in the hydrogen fuel and pressure of hydrogen fuel. In step 238, a signal controls the injection of the hydrogen fuel into the air intake system to produce the predetermined hydrogen to air ratio. In step 240, in an embodiment with an electrolyzer, the generation of hydrogen fuel by the hydrogen fuel source is controlled in response to the determined flow rate for the hydrogen fuel. The process then continues back to step 232. As the operational conditions of the internal combustion engine 100 changes, the control module 120 continues to monitor the air flow rate and adjust the hydrogen flow rate into the air intake system to produce a predetermined hydrogen to air ratio. The predetermined hydrogen to air ratio may be adjusted depending on the type of engine. For example, the hydrogen to air ratio may range from 0.01% to 10.0% for certain diesel engines and more or less than this ratio for other types of engines. In an embodiment, the hydrogen to air ratio will be less than 3%.

Embodiments of the present invention are thus able to adjust the delivery of the volume or flow rate of the hydrogen fuel to maintain an approximately predetermined hydrogen to air ratio with varying engine RPM and load conditions of the internal combustion engine. This adjustment helps to increase efficiency of the combustion process over the engine's operating range. With hydrogen gas blending, the emissions of internal combustion engines are greatly reduced across the operating range of the engine.

In an embodiment, the predetermined hydrogen to air ratio may not be a constant across the range of operational data of the sensors. For example, the predetermined hydrogen to air ratio may be less at lower engine RPM and/or load and greater for higher engine RPM and/or load. Thus, the control module 120 may vary the hydrogen to air ratio in response to the operational data. The control module 120 then controls the hydrogen injector 122 to provide a flow rate of hydrogen fuel that provides the predetermined hydrogen to air ratio corresponding to the operational data of the internal combustion engine 100.

In an embodiment, the hydrogen fuel includes hydrogen, oxygen and water vapor. In another embodiment, other alternative fuels are used such as methane, propane and any combination of these gases or other hydrogen/carbon based gases. When other alternative fuels are incorporated into the hydrogen fuel, or used in place of the hydrogen in the fuel, embodiments in FIGS. 1 through 16 may also be used to deliver such other alternative fuels to an engine block assembly 104 in a similar manner. As described herein, the control module 120 determines a flow rate of the alternative fuel in response to one or more measurements of operational data from sensors 124a-n of the internal combustion engine 100. The control module 120 then controls an injector to provide the flow rate of the alternative fuel into the air intake system or to the engine block assembly 104.

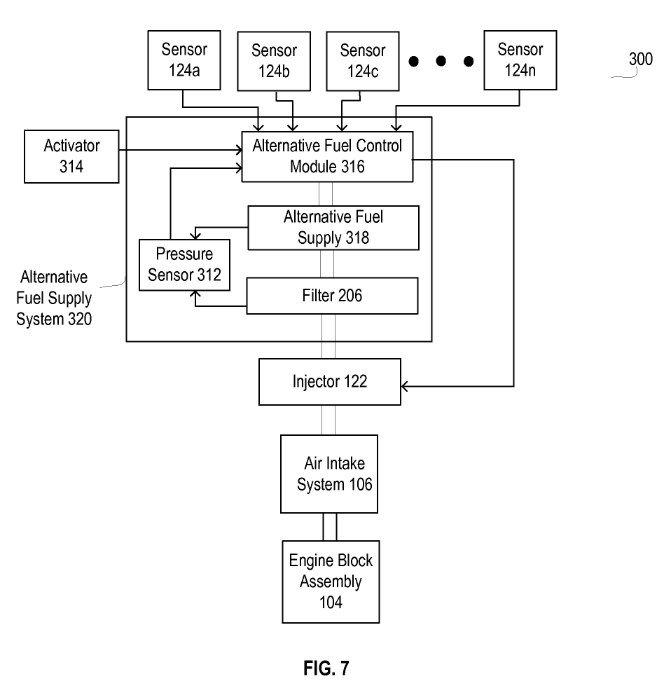

FIG. 7 is a schematic block diagram of an embodiment of an alternative fuel delivery system 300. The alternative fuel control module 316 controls the injection of alternative fuel into the air intake system 106 and the alternative fuel supply system 320. In an embodiment, the alternative fuel control module 316 is also operable to regulate production of alternative fuel by the alternative fuel supply 318. In an embodiment, the alternative fuel control module 316 is coupled to an activator 314. The activator 314 signals the alternative fuel control module 316 to start or terminate production of alternative fuel and delivery of alternative fuel to the air intake system 106. In an embodiment, the activator 314 is an ignition switch for the internal combustion engine 100 or other type of switch. The alternative fuel control module 316 is also coupled to a pressure sensor 312. The pressure sensor 312 is coupled to the alternative fuel supply 318 or other component of the alternative fuel supply system 320 to measure the pressure of the alternative fuel. In an embodiment, the alternative fuel supply 318 is an electrolyzer, plasma reformer, steam reformer, catalytic reforming module or other generator that is operable to produce hydrogen or other alternative fuels.

In an embodiment, the alternative fuel control module 316 receives a signal from activator 314. In response to the signal from the activator 314, the alternative fuel control module 316 signals the alternative fuel supply to begin production of alternative fuel or terminates production of alternative fuel or otherwise control production of the alternative fuel. For example, the activator 314 signals the alternative fuel control module 316 to start production when the internal combustion engine 100 is started. When the internal combustion engine 100 is turned off, the activator 314 signals the alternative fuel control module 316 to terminate production.

The alternative fuel control module 316 also controls the injector 122 to open and close. In an embodiment, the alternative fuel control module 316 controls the injector 122 to deliver a predetermined flow rate of alternative fuel to the air intake system 106.

The alternative fuel control module 316 monitors one or more measurements of operational data of the internal combustion engine 100 from one or more sensors 124a-n. The operational data comprises, inter alia, mass air flow (MAF), volume air flow, engine load, fuel flow measurement, intake vacuum on a turbocharger, turbocharger rotor speed, amount of fuel injected into the intake or combustion chamber, temperature, engine RPM, manifold absolute pressure (MAP), throttle position, engine load, crank shaft position and other types of measurements from sensors 124a-n described herein.

Based on one or more measurements of operational data of the internal combustion engine 100, the alternative fuel control module 316 controls the alternative fuel supply 318 to produce alternative fuel. The alternative fuel control module 316 determines an amount of alternative fuel to be injected into the air intake system 106 and a fuel flow rate of alternative fuel needed to deliver the determined amount of alternative fuel. The alternative fuel control module 316 then controls the injector 122 to deliver alternative fuel to the air intake system. In an embodiment, the alternative fuel control module 316 also controls production of alternative fuel based on pressure measurements from the pressure sensor. The pressure measurements should be maintained within a predetermined operational range to provide the optimal pressure for injection of the alternative fuel to the intake system.

In an embodiment, the alternative fuel control module 316 determines an amount of alternative fuel to be injected into the air intake system 106 based on measurements indicative of load on the engine. In an embodiment, the sensors 124a-n measure one way and two way fuel flow measurements to determine engine load. Two way fuel flow sensors measure fuel flowing from a fuel tank and any fuel returning to the tank. Fuel consumption may then be determined. The alternative fuel control module 316 then determines engine load based on fuel consumption. In another embodiment, engine load is determined based on one or more other measurements of operational data from sensors 124a-n. Depending on the engine load measurements, the alternative fuel control module 316 determines an alternative fuel flow rate and alternative fuel production rate by the alternative fuel supply 318. In an embodiment, the alternative fuel supply 318 may be a plasma reformer or a steam reformer. The alternative fuel control module 316 then controls production of hydrogen fuel by the plasma reformer or steam reformer by controlling injection of carbon based feed fuel into the plasma reformer or steam reformer. The alternative fuel control module 316 can thus vary the rate of production of hydrogen fuel in response to the amount of alternative fuel needed to provide the desired alternative fuel flow rate.

The alternative fuel control module 316 also receives pressure measurements from the pressure sensor 312 and determines whether the pressure of the alternative fuel is within operating conditions. When the pressure exceeds or falls below operating parameters, the alternative fuel control module 316 adjusts the operation of the alternative fuel supply 318 and possibly, if needed, the injector 122 in an attempt to bring the pressure back into operating parameters. For example, to control the pressure of the alternative fuel in the alternative fuel supply 318, the alternative fuel control module 316 adjusts production of alternative fuel by the alternative fuel supply 318 and the fuel flow rate into the air intake system. The alternative fuel control module 316 also controls operation of a safety shut off valve 174, as shown in FIG. 3.

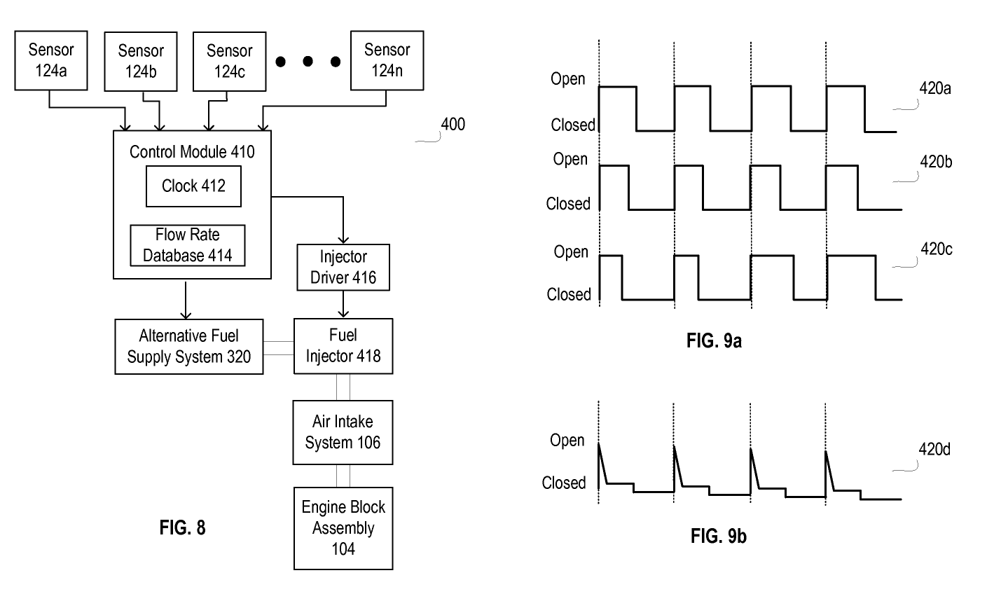

FIG. 8 is a schematic block diagram of another embodiment of an alternative fuel delivery system 400 in accordance with the present invention. The alternative fuel delivery system 400 may be external or incorporated into the internal combustion engine 100. The alternative fuel delivery system 400 includes a control module 410. The control module 410 may include the alternative fuel control module 316 in FIG. 7 or the control module 120 shown in FIGS. 1 through 6. In an embodiment, the alternative fuel supply 420 includes an electrolyzer, plasma reformer, steam reformer, or catalytic reforming module or another alternative fuel generator that is operable to produce hydrogen or another alternative fuel. In another embodiment, the alternative fuel supply may include an alternative fuel storage module, such as a high pressure tank. The alternative fuel supply 420 may also include a combination of an alternative fuel storage module and an alternative fuel generator.

In an embodiment, the control module 410 includes an internal clock 412 and flow rate database 414. The alternative fuel control module 316 in FIG. 7 or the control module 120 shown in FIGS. 1 through 6 may also incorporate the components and functions of control module 410. The control module 410 is coupled to a plurality of sensors 124a-n, to injector driver 416 and to alternative fuel supply 420. The injector driver 416 may be a separate component or may be incorporated into the fuel injector 418 or control module 410.

In operation, the control module 410 signals the injector driver 416 to operate the fuel injector 418. In an embodiment, the control module 410 pulses the injector driver 416 to open and close the fuel injector 418 at a predetermined frequency or rate of operation. The rate of operation can be set based on the operating parameters of the fuel injector 418 or type of internal combustion engine 100 or air intake system 106 parameters. For example, the fuel injector 418 may only be operable at a rate of operation of four cycles per second—e.g. it may only be operable to open and then close four times per second. In an embodiment, the control module 410 generates a control signal to vary a duration of opening of the fuel injector and maintain a predetermined rate of operation of the fuel injector 418 in response to a rate of operation set at the internal clock 412.

FIGS. 9a and 9b are a schematic diagram of an embodiment of example control signals 420 from the control module 410 in the alternative fuel delivery system 400 in accordance with the present invention. FIG. 9a illustrates example control signal 420a, control signal 420b and control signal 420c. The control signal 420 is transmitted from control module 410 to injector driver 416. In an embodiment in FIG. 9a, the control module 410 generates a control signal 420 with pulse width modulation to vary the fuel flow rate and maintain a predetermined rate of operation of the fuel injector 418 in response to the clock 412. In this example, the control signals are square waves with a high or pulse signal controlling the injector driver 416 to open the fuel injector 418 and a low signal or no signal controlling the injector driver 416 to close the fuel injector 418. FIG. 9b illustrates a peak and hold control signal 420d. In this example, the control signal 420d signals the injector driver 416 to open with a peak signal and to remain open until the signal falls beneath a threshold. Other types of control signals at different rates of operation and with different modulation may be used to signal the injector driver 416 to operate the fuel injector 418 as well.

In this example of FIG. 9, each control signal 420 has a rate of operation of four cycles per second. For each cycle, the injector driver controls the fuel injector 418 to open, e.g. to inject the alternative fuel, for a duration of the cycle and then to close for a duration of the cycle. In response to the predetermined rate of operation, the control module 410 determines a duration of the cycle to inject the alternative fuel to achieve a desired fuel flow rate of alternative fuel. For example, control signal 420a has a first duration, or pulse width, that signals the fuel injector 418 to remain open. Control signal 420b has a second duration or pulse width. Since the pulse width or duration of the cycle that the fuel injector 418 is injecting alternative fuel is shorter in control signal 420b, the flow rate of alternative fuel will be less than with control signal 420a assuming other parameters (such as hydrogen pressure) are constant. The pulse width of a control signal 420 may be modified between cycles as seen in control signal 420c. The control module 410 may determine that the fuel flow rate of alternative fuel needs to increase or decrease and thus modify the pulse width of control signal 420. Control signal 420d in FIG. 9b is a peak and hold signal that would provide a similar fuel flow rate as with control signal 420a. Similarly with control signals 420a-c, the peak and hold control signal 420d may be modified to increase or decrease the fuel flow rate while maintaining a predetermined rate of operation of the fuel injector 418. As such, the control module 410 is able to control the fuel flow rate of alternative fuel by varying the duration of injection of the alternative fuel during a cycle while maintaining a predetermined rate of operation of the fuel injector 418.

With the use of internal clock 412, the predetermined rate of operation of the fuel injector 418 can be set independent of RPM or other operational data of the internal combustion engine 100. In addition, because the alternative fuel is injected into the air intake system, the predetermined rate of operation of the fuel injector does not need to be dependent on engine RPM. As such, there is no requirement of modification of the rate of operation of the fuel injector 418 with the RPM or precise timing of the fuel injection at a set point in time of a piston cycle as in implementations with direct injection.

In an embodiment, the control module 410 includes a flow rate database 414. The flow rate database 414 includes operational data of the internal combustion engine 110 and corresponding predetermined fuel flow rates of alternative fuel.

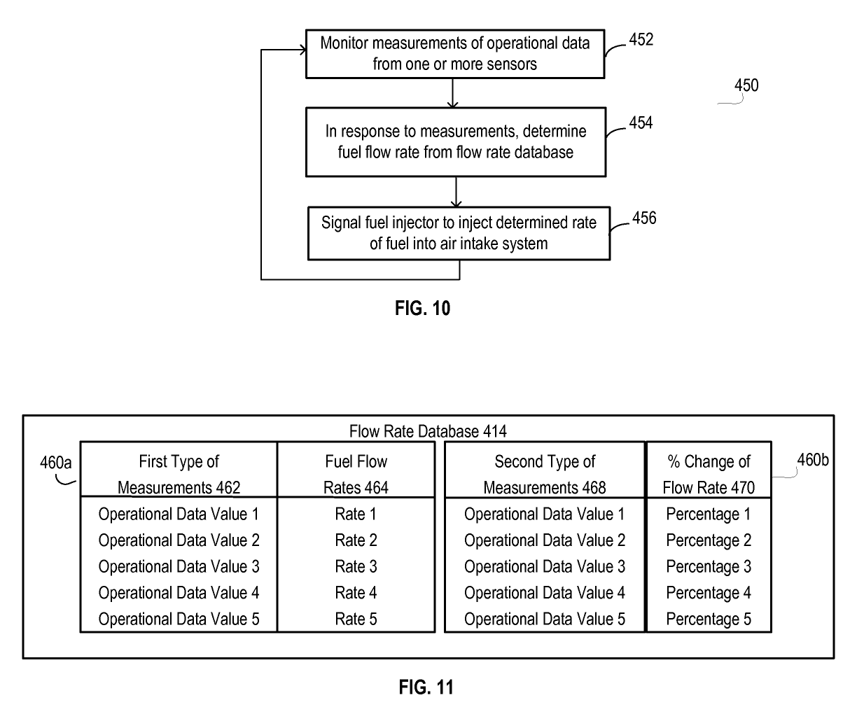

FIG. 10 illustrates an embodiment of a method for alternative fuel delivery including the flow rate database 414. In step 452, the control module 410 monitors measurements of operational data of the internal combustion engine 110 from one or more sensors 124a-n. In response to the operational data, the control module 410 accesses the flow rate database 414 and determines a corresponding fuel flow rate of alternative fuel in step 454. The control module 410 then controls the fuel injector 418 to provide the determined fuel flow rate of alternative fuel into the air intake system 106 in step 456. The control module 410 is thus operable to vary the fuel flow rate of alternative fuel in response to the operational data of the internal combustion engine 110.

FIG. 11 illustrates a schematic block diagram of an embodiment of the flow rate database 414. The flow rate database 414 includes fuel flow rates corresponding to measurements of operational data for specific types of internal combustion engines 100. The flow rate database 414 includes one or more tables 460. In an embodiment, a first table 460a includes measurements of operational data 462 and corresponding fuel flow rates 464. In another embodiment, a first table 460a includes a first type of measurement of operational data 462 and corresponding fuel flow rates 464 and a second table 460b includes a second type of measurement of operational data 468 and corresponding percentage change of fuel flow rate 470 from the fuel flow rates 464 in the first table 460a.

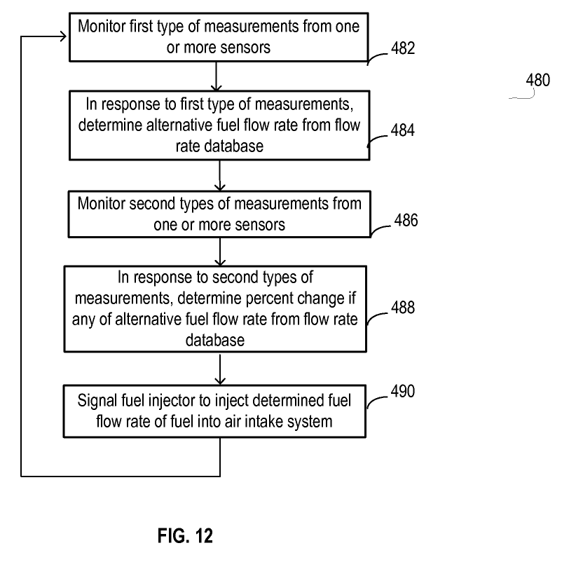

FIG. 12 illustrates a logic flow diagram of an embodiment of a method 480 for alternative fuel delivery including the flow rate database 414. In step 482, the control module 410 monitors a first type of measurement of operational data from one or more sensors 124a-n. In response to the operational data, the control module 410 accesses the first table 460a in the flow rate database 414 and determines a corresponding fuel flow rate of alternative fuel in step 484. In step 486, the control module 410 monitors a second type of measurement of operational data from one or more sensors 124a-n. In response to the operational data, the control module 410 accesses the second table 460b in the flow rate database 414 and determines a corresponding percentage change of fuel flow rate 470 in step 488. The control module may monitor multiple second types of measurements from one or more sensors 124a-n wherein each of the second types of measurements provides a corresponding percentage change of fuel flow rate 470. The control module 410 then controls the fuel injector 418 to provide the determined fuel flow rate of alternative fuel into the air intake system 106 in step 490.

For example, in an embodiment, the first table 460a includes a first type of measurement 462 indicative of engine load, such as manifold absolute pressure (MAP) or RPM, and a corresponding list of fuel flow rates. The second table 460b includes a second type of measurements 468 indicative of air flow through the air intake system 106 and a corresponding percentage change of fuel flow rate 470 for the air flow measurements 468. For a certain manifold absolute pressure that indicates an engine load of, e.g. 25%, the first table 460a lists a corresponding fuel flow rate 464. The second table lists a percentage change of fuel flow rate for the air flow measurements 468. The fuel flow rate 464 from the first table is increased or decreased by the percentage change 470 listed in the second table 460b. This example of an embodiment of a flow rate database 414 is preferably implemented for compression ignition internal combustion engines, such as diesel or biodiesel engines. In these types of engines, the load is a primary measurement for engine operation while the air flow measurements through the air intake system are a secondary measurement for engine operation.

In another embodiment, the first table 460a includes a first type of measurement 462 indicative of air flow through the air intake system, such as volume air flow or mass air flow (MAF), and a corresponding list of fuel flow rates. The second table 460b includes a second type of measurement 468 indicative of engine load, such as manifold absolute pressure (MAP) or RPM, and a corresponding percentage change of fuel flow rate 470 from the fuel flow rate 464 in the first table 460a. This example of an embodiment of a flow rate database 414 is preferably implemented for spark ignited internal combustion engines, such as gasoline, natural gas, liquid propane, ethanol, or biofuel type engines. In these types of engines, the air flow rate through the air intake system is a primary measurement for engine operation while the load is a secondary measurement for engine operation.

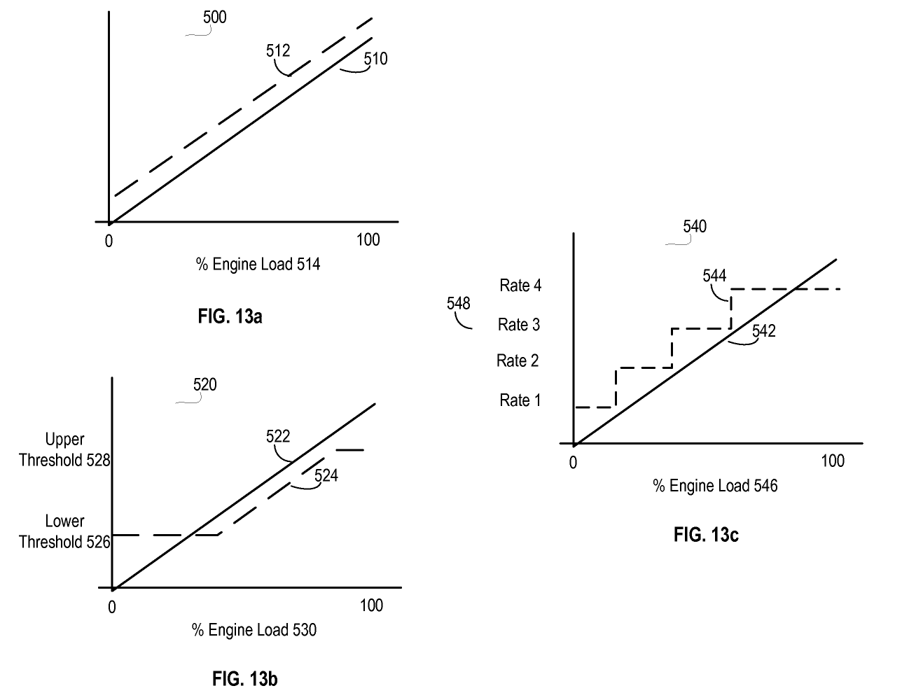

FIGS. 13a-c illustrate graph diagrams of different examples of alternative fuel flow rates in an embodiment of flow rate database 414. In the graph 500 in FIG. 13a, a first solid line 510 illustrates an example of a load measurement of operational data indicative of engine load 514, e.g. MAP. As seen in graph 500, a dotted line illustrates the fuel flow rate 512. The alternative fuel flow rate 512 in this example increases proportionately with the load measurement 510 of operational data.

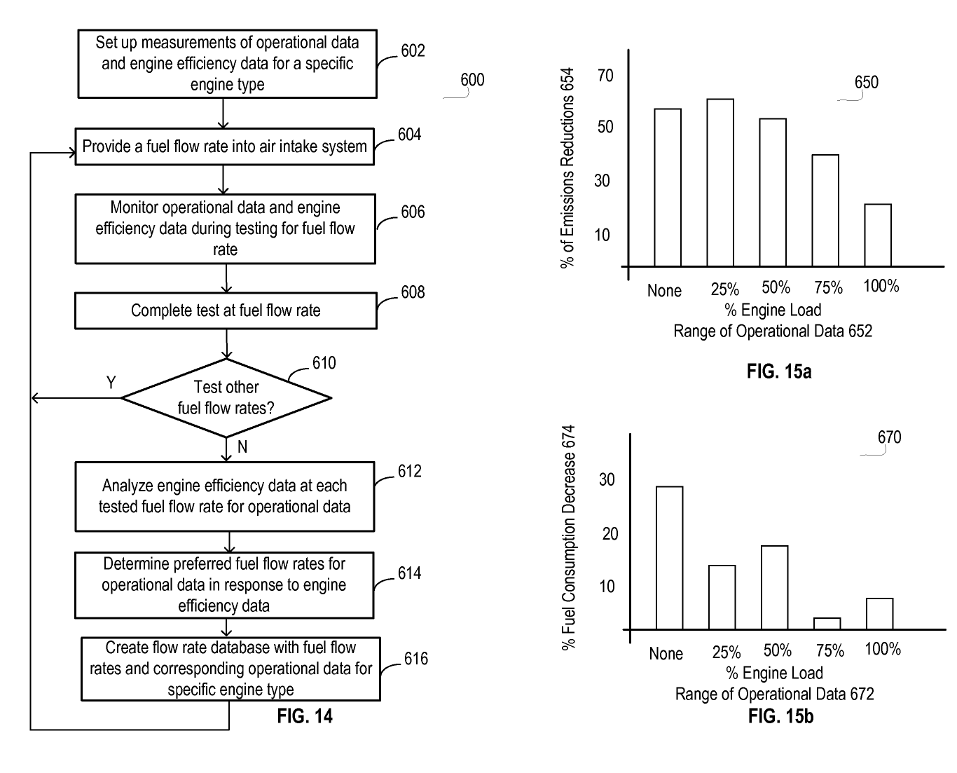

In the graph 520 in FIG. 13b, the solid line 522 again illustrates an example of a load measurement of operational data while the dotted line illustrates the alternative fuel flow rate 524. The alternative fuel flow rate 524 in this example increases proportionately with the load measurement of operational data except that it has a lower threshold 526 and upper threshold 528. In an embodiment, the thresholds are determined based on load range of the engine. For example, the internal combustion engine 100 may operate more efficiently with at least a lower threshold 526 for the alternative fuel flow rate and may not operate more efficiently with increasing alternative fuel flow rates after an upper threshold 528. Determination of alternative fuel flow rates based on efficiency of engine operation is discussed in more detail with respect to FIGS. 14 and 15.

In the graph 540 in FIG. 13c, the solid line 542 again illustrates an example of a load measurement of operational data while the dotted line illustrates the alternative fuel flow rate 544. The alternative fuel flow rates 544 in this example increase in incremental steps. In this embodiment, to reduce the number of fuel flow rate changes, the flow rate database 414 includes a range of operational data corresponding to an alternative fuel flow rate. The alternative fuel flow rate changes in incremental steps in response to one or more ranges of operational data.

FIG. 14 illustrates a logic flow diagram of a method 600 for determining alternative fuel flow rates at varying operational conditions in response to measurements of engine efficiency data for a specific engine type. In step 602, a test is set up to measure engine operational data and engine efficiency data for a specific engine type. The measurements of operational data are collected from the plurality of sensors 124a-n as described herein. Engine efficiency data includes, inter alia, measurements and calculations of engine emission reductions, fuel consumption, fuel costs, fuel availability, engine maintenance costs, thermal efficiency and volumetric efficiency. For example, emissions of various gases, such as hydrocarbons, carbon monoxide, carbon dioxide, nitrous oxides, oxygen, particulate matter (PM) and smog are measured and recorded in the test. In another example, consumption of alternative fuel and consumption of primary fuel, such as gasoline or diesel, or other fuels necessary for the internal combustion engine 100 are measured and recorded in the test.

In step 604, the test is performed with a first predetermined fuel flow rate of alternative fuel into the air intake system. In step 606, the engine efficiency data is measured and recorded for the first predetermined fuel flow rate over a range of engine operational conditions as measured by the sensors 124a-n, such as engine load, RPM and air flow in the air intake system. In step 608 the test is completed for the first predetermined fuel flow rate. In step 610, other predetermined fuel flow rates are tested as described in steps 604 through 608 in an iterative manner until all desired fuel flow rates have been tested. In step 612, an analysis is performed of the engine efficiency data for tested predetermined fuel flow rates over a range of engine operational data. This analysis is explained in more detail with respect to FIG. 15. In step 614, a corresponding fuel flow rate is determined for engine operational data in response to the engine efficiency data. In step 616, one or more tables for the fuel flow rate database 414 are created based on the test results for the specific engine type.

FIG. 15 illustrates bar graphs that provide an example of an analysis performed of the engine efficiency data for tested predetermined fuel flow rates. FIG. 15a illustrates a bar graph 650 with ranges of engine operational data 652 from the tests. In this example, the range of operational data 652 is the percentage of engine load as determined from one or more load measurements from the sensors 124a-n during the tests. The bar graph illustrates a percentage of emissions reductions 654 for the range of operational data 652 at a tested fuel flow rate. By comparing the results of the tested fuel flow rates, the fuel flow rates for operational data with preferred emissions reductions are determined.

FIG. 15b illustrates a bar graph with ranges of engine operational data 672. In this example again, the range of operational data 672 is the percentage of engine load as determined from one or more load measurements from the sensors 124a-n. The bar graph illustrates a percentage of fuel consumption decrease (such as diesel fuel for a diesel engine) over the range of operational data 672 at a tested fuel flow rate. By comparing the results for the tested fuel flow rates, the fuel flow rates over a range of operational data with preferred fuel consumption decrease are determined.

The analysis of the engine efficiency data is performed to determine preferred fuel flow rates of alternative fuel into the air intake system for corresponding operational data. Engine efficiency data includes, inter alia, engine emission reductions, fuel consumption, fuel costs, fuel availability, engine maintenance costs, thermal efficiency and volumetric efficiency. Depending on the application, one or more factors of engine efficiency may be assigned more weight in determining fuel flow rates. For example, in applications needing lower emissions, the percent reduction of emissions is assigned more weight in the analysis than other factors of engine efficiency, such as fuel consumption reductions or fuel cost reductions. The fuel flow rates of alternative fuel corresponding to operational data are then determined in response to weighted engine efficiency data.

In an embodiment, the analysis also determines fuel flow rates for a first type of measurement of operational data and a second type of operational data in response to engine efficiency data for a specific type of engine. For example, engine efficiency data varies more widely in response to load measurements indicative of load on the engine, such as MAP, with compression ignition engines. Thus, a first table with a list of load measurements, such as MAP, of operational data and corresponding fuel flow rates is determined. In addition, engine efficiency data for diesel engines does vary at extreme air flow measurements in the air intake system. So a second table with a list of air flow measurements and a corresponding percentage change of fuel flow rate is determined. The percentage change is multiplied by the determined fuel flow rate in the first table to determine the fuel flow rate. In an embodiment, the analysis determines fuel flow rates for a first type of measurement of operational data. For example, for gasoline engines in vehicles, engine efficiency data varies widely for air flow measurements in the air intake system. A first table with air intake measurements of operational data and corresponding fuel flow rates is determined and implemented in a control module for a gasoline engine in a vehicle. In another embodiment, a plurality of types of measurements are included in one or more tables with corresponding fuel flow rates or percentage change of fuel flow rates.

The alternative fuel delivery system 400 can be installed on existing internal combustion engines as well as constructed as part of a new internal combustion engine. It should further be understood that the above described embodiments are not limited to any particular shape, dimensions or size or materials. The alternative fuel delivery system 400 may be adjusted in scale and in shape to be operable with various types and capacities of internal combustion engines. For example, the alternative fuel delivery system 400 may be scaled to be operable with 1.0 L gasoline engine for a vehicle or 100 L diesel engine for a generator.

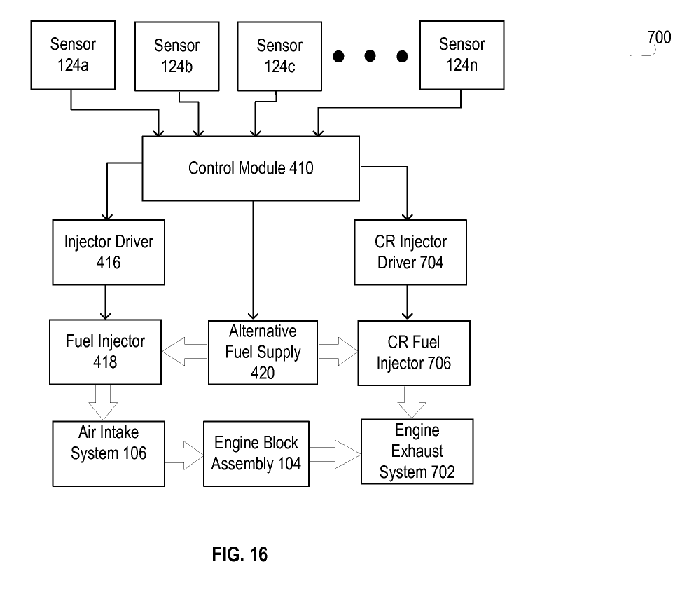

FIG. 16 illustrates another embodiment of an alternative fuel delivery system 700. In this embodiment, alternative fuel is injected into the air intake system 106. In addition, the alternative fuel is injected into the engine exhaust system 702. The alternative fuel mixes with the exhaust gases to reduce oxides of nitrogen (NOₓ) emissions as part of a selective catalytic reduction (SCR) system. In an embodiment, the sensors 124a-n measure operational data of the engine exhaust system 702. For example, in an embodiment, the sensors 124a-n measure one or more of oxygen content in the exhaust fumes, exhaust temperature or NOₓ levels in the exhaust system 702. The sensors 124-n also measure engine operational data as described herein. In response to the operational data, the control module signals the catalytic reduction (CR) injector driver 704 to control the CR fuel injector 706 to deliver a fuel flow rate of alternative fuel to the engine exhaust system 702. The control module 410 varies the alternative fuel flow rate to the engine exhaust system 702 in response to the operational data. The alternative fuel flow rate to the engine exhaust system 702 can be determined based on testing of various operational measurements and alternative fuel flow rates and resulting reduction of greenhouse gases in the engine exhaust system 702. Testing procedures may be used that are similar to that described in FIGS. 12 and 13.

Oxides of nitrogen (NOₓ) are a byproduct of high temperature combustion and found as part of the emissions in the engine exhaust system 702. The alternative fuel is added to the emissions in the engine exhaust system 702 and acts as a reductant for catalytic reduction of the nitrogen oxides (NOₓ) or other greenhouse gases found in the engine exhaust system 702. The alternative fuel and emissions mixture enters a catalyst chamber in the engine exhaust system 702 and is absorbed onto a catalyst. The nitrogen oxides (NOₓ) are converted into diatomic nitrogen N₂ and water or water vapor, H₂O. In an embodiment, the alternative fuel used in the catalytic reduction is hydrogen. Anhydrous ammonia, aqueous ammonia, or urea may also be used in the process or other alternative fuels.

The embodiments of the invention described are not limited to the exact details of construction, operation, exact materials or embodiments shown and described, but includes modifications and equivalents that are apparent to one skilled in the art. As may be used herein, the term “approximately” provides an industry-accepted tolerance for its corresponding term. Such an industry-accepted tolerance ranges from less than one percent to fifty percent and corresponds to, but is not limited to, ratio values, process variations, temperature variations, etc.

As may also be used herein, the terms “coupled to” or “coupling” includes direct coupling between items and/or indirect coupling between items via an intervening item (e.g., an item includes, but is not limited to, a component, an element, a circuit, and/or a module) so that the items are operable for their intended purpose. As may further be used herein, inferred coupling (i.e., where one element is coupled to another element by inference) includes direct and indirect coupling between two items in the same manner as “coupled to”. As may even further be used herein, the term “operable to” or “operatively” indicates that an item includes elements necessary to perform one or more of its corresponding functions and may further include inferred coupling to one or more other items. As may still further be used herein, the term “associated with”, includes direct and/or indirect coupling of separate items and/or one item being embedded within another item.

Embodiments of the present invention have also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Embodiments of the present invention have been described above with the aid of schematic block diagrams that are functional building blocks illustrating the performance of certain significant functions. The boundaries of these functional building blocks have been arbitrarily defined for convenience of description. Alternate boundaries could be defined as long as the certain significant functions are appropriately performed. One of average skill in the art will also recognize that the functional building blocks can be implemented as illustrated or by including other functional building blocks into a single functional building block or separating a functional building block into more than one component or including additional or alternative building blocks that perform similar functions.

What is claimed is:

1. An internal combustion engine, comprising:
an engine block assembly,
an air intake system coupled to the engine block assembly; and
a fuel delivery system coupled to the air intake system, wherein the fuel delivery system controls injection of an alternative fuel into the air intake system at an alternative fuel flow rate that varies in response to one or more measurements of operational data.

2. The internal combustion engine of claim 1, wherein the fuel delivery system further comprises:
a control module; and
one or more sensors coupled to the internal combustion engine and to the control module for providing measurements of operational data of the internal combustion engine to the control module.

3. The internal combustion engine of claim 2, wherein the one or more sensors provide at least one of: air flow measurements, engine load measurement and revolutions per minute (RPM) measurements.

4. The internal combustion engine of claim 3, wherein the control module is operable to:
monitor the measurements of operational data of the internal combustion engine from the one or more sensors;
in response to the operational data, access a flow rate database to determine an alternative fuel flow rate of alternative fuel; and
control injection of the alternative fuel to provide the determined fuel flow rate of alternative fuel into the air intake system.

5. The internal combustion engine of claim 4, wherein flow rate database comprises:
a first table that includes a list of a first type of measurements of operational data and a corresponding list of fuel flow rates for a specific type of engine.

6. The internal combustion engine of claim 5, wherein the flow rate database includes a second table that includes a list of a second type of measurements of operational data and a list of corresponding percentage changes of fuel flow rates for a specific type of engine.

7. The internal combustion engine of claim 6, wherein the specific type of engine is a compression ignition type engine and the first type of measurements are load measurements and the second type of measurements are air flow measurements from the air intake system.

8. The internal combustion engine of claim 6, wherein the specific type of engine is a spark ignition type engine and the first type of measurements are air flow measurements from the air intake system and the second type of measurements are load measurements.

9. The internal combustion engine of claim 6, wherein the list of corresponding fuel flow rates for the list of the first type of measurements of operational data are determined in response to engine efficiency data.

10. The internal combustion engine of claim 9, wherein the list of corresponding percentage changes of fuel flow rates of the second type of measurements of operational data are determined in response to engine efficiency data.

11. The internal combustion engine of claim 4, wherein the fuel delivery system further comprises:
a fuel injector;
an injector driver operable to control the fuel injector in response to a control signal from the control module; and
wherein the control module includes an internal clock and transmits a control signal to the injector driver to vary the fuel flow rate and maintain a predetermined rate of operation of the fuel injector as set by the internal clock.

12. The internal combustion engine of claim 11, wherein the control signal has pulse width modulation.

13. The internal combustion engine of claim 11, wherein the control signal has peak and hold modulation.

14. A method for alternative fuel delivery to an air intake system of an internal combustion engine, comprising:
monitoring operational data from one or more sensors coupled to the internal combustion engine; and
adjusting a fuel flow rate of alternative fuel injected into the air intake system in response to the operational data from the one or more sensors, wherein adjusting the fuel flow rate of alternative fuel includes:
in response to the operational data, accessing a flow rate database to determine a fuel flow rate of alternative fuel corresponding to the operational data; and
controlling injection of the alternative fuel to provide the determined fuel flow rate of alternative fuel into the air intake system.

15. The method of claim 14, wherein the alternative fuel includes hydrogen fuel and further comprising:
controlling a hydrogen fuel source to regulate production of hydrogen fuel in response to the determined fuel flow rate of hydrogen fuel.

16. The method of claim 15, wherein the hydrogen fuel source comprises at least one of:
electrolyzer, plasma reformer, steam reformer, catalytic reformer, organic feed stock reformer and high pressure hydrogen storage module.

17. The method of claim 14, wherein monitoring operational data from one or more sensors coupled to the internal combustion engine comprises monitoring at least one of the following: air flow measurements, load measurements and revolutions per minute (RPM) measurements.

18. The method of claim 17, wherein the flow rate database includes a first table having a list of load measurements of operational data and a corresponding list of fuel flow rates for a specific type of engine and a second table having a list of air flow measurements of operational data and a list of corresponding percentage changes of fuel flow rates for a specific type of engine.

19. The method of claim 17, wherein the flow rate database includes a table that includes a list of air flow measurements of operational data and a corresponding list of fuel flow rates.

20. The method of claim 17, wherein the flow rate database includes a table that includes a list of load measurements of operational data and a corresponding list of fuel flow rates.

21. The method of claim 14, wherein the fuel flow rate of alternative fuel corresponding to the operational data in the flow rate database is determined in response to engine efficiency data.

22. The method of claim 21, wherein engine efficiency data includes at least one of the following: engine emission reductions, fuel consumption, fuel costs, fuel availability, engine maintenance costs, thermal efficiency and volumetric efficiency.

23. The method of claim 14, wherein controlling injection of the alternative fuel to provide the determined fuel flow rate of alternative fuel into the air intake system, comprises:
maintaining a predetermined rate of operation of a fuel injector by an internal clock; and
varying duration of injection during each cycle of the predetermined rate of operation to vary the fuel flow rate of alternative fuel.

24. The method of claim 14, further comprising:
injecting an alternative fuel into an engine exhaust system at a fuel flow rate in response to the measurements from the one or more sensors, wherein the alternative fuel reacts with engine emissions in the engine exhaust system for catalytic reduction of the engine emissions.
